(19) United States
(12) Patent Application Publication
(10) Pub. No.: US 2011/0041570 A1
(43) Pub. Date: Feb. 24, 2011

(54) TWO-WAY OPENED PADLOCK

(76) Inventor: CHIEN-YUNG HUANG, Banchiao City (TW)

Correspondence Address: PRO-TECHTOR INTERNATIONAL SERVICES, 20775 NORADA CT., SARATOGA, CA, 95070, US

(21) Appl. No.: 12/544,180

(22) Filed: Aug. 19, 2009

(51) Int. Cl. E05B 67/00

(52) U.S. Cl. 70/21

(57) ABSTRACT

A two-way opened padlock is provided with three dials and a key hole in a housing. The padlock enables using the dials or inserting a key into the key hole, to open and close the lock. A tail end of a cable is obliquely fixed on the housing and by elasticity of the cable itself, the padlock can be configured more sophisticated and tinier in a slender space. In addition, when the housing is hit, the oblique cable is not likely to be damaged.

### BACKGROUND OF THE INVENTION

a) Field of the Invention

The present invention relates to a two-way opened padlock, and more particularly to a Continuation-In-Part of the U.S. Patent Ser. No. 12,196,289, with a tail end of a cable being obliquely fixed on a housing.

b) Description of the Prior Art

There are three types of conventional combination padlocks using a cable, as described below.

Referring to FIG. 1, a conventional padlock includes a housing 100 which is disposed with three dials 101 and a key hole 102. This padlock not only enables using the dials 101 to open a lock, but also allows a key A to be inserted into the key hole 102 to open the lock. A top end of the housing 100 is provided with a lock hole 103 and a surface perpendicular to the lock hole 103 is provided with a round hole 104. Head ends 1051, 1052 at two sides of a cable 105 can be put into the lock hole 103 and the round hole 104 respectively for locking. As the cable 105 is bended from the lock hole 103 and straight put into the round hole 104, when the lockset is hit, the head end 1052 of the cable 105 which is inserted into the round hole 104 is easily damaged and difficult to be put into a narrow space of the housing 100. In addition, the key A is inserted in a same direction as that of a shaft inside the dials 101.

Referring to FIG. 2, another conventional padlock includes a housing 200 which is disposed with three dials 201 and a key hole 202. A top end of the housing 200 is provided with two lock holes 203, 204 and head ends 2051, 2052 at two sides of a cable 205 can be put into the lock holes 203, 204 respectively for locking. As the top surface of the slender housing 200 is provided with two lock holes 203, 204 which are too close to each other, movable parts inside the housing 200 will be difficult to be configured. Furthermore, as the top surface structure of the housing 200 is not strong enough and the cable 205 itself is elastic, it will be difficult to put the two head ends 2051, 2052 into the lock holes 203, 204. In addition, the key A is inserted in a same direction as that of a shaft inside the dials 201.

Referring to FIG. 3, still another conventional padlock includes a housing 300 which is disposed with three dials 301 and a key hole 302. A top end of the housing 300 is provided with a round hole 303, a tail end of a cable 304 is fixed at the top end of the housing 300 and a head end 3041 at the other end of the cable 304 can be put into the round hole 303 for locking. As the top surface of the slender housing 300 is provided with the round hole 303 and fixes the tail end of the cable 304, these two structures which are too close to each other will allow movable parts inside the housing 200 to be difficult to be configured. In addition, elasticity of the cable 304 itself will allow the head end 3041 to be difficult to be put into the round hole 303. In addition, the key A is inserted in a same direction as that of a shaft inside the dials 301.

### SUMMARY OF THE INVENTION

The primary object of the present invention is to provide a two-way opened padlock, wherein a housing of the padlock comprises three dials and a key hole. Apart from that the padlock enables the dials to open and close a lock, a key can be also inserted into the key hole to open the lock. The present invention is characterized by that the key is inserted into the key hole in a direction perpendicular to a shaft in the dials, which is different from the equidirectional configuration of the conventional lockset. Moreover, a tail end of a cable is obliquely fixed at a side of the housing. Due to elasticity of the cable itself, a shape of the housing can be more sophisticated and tinier and when the housing is hit, the cable is not likely to be damaged.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a conventional elevational view of a first embodiment of a prior art.

FIG. 2 shows a conventional elevational view of a second embodiment of a prior art.

FIG. 3 shows a conventional elevational view of a third embodiment of a prior art.

FIG. 4 shows a schematic view of the present invention.

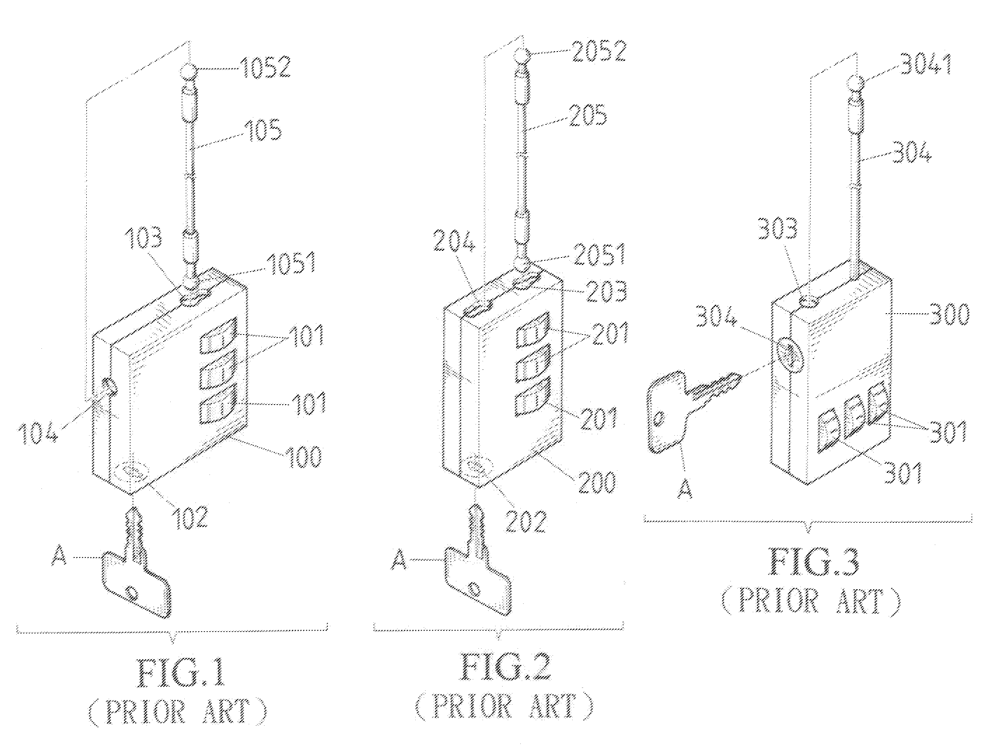

### DETAILED DESCRIPTION OF THE PREFERRED EMBODIMENTS

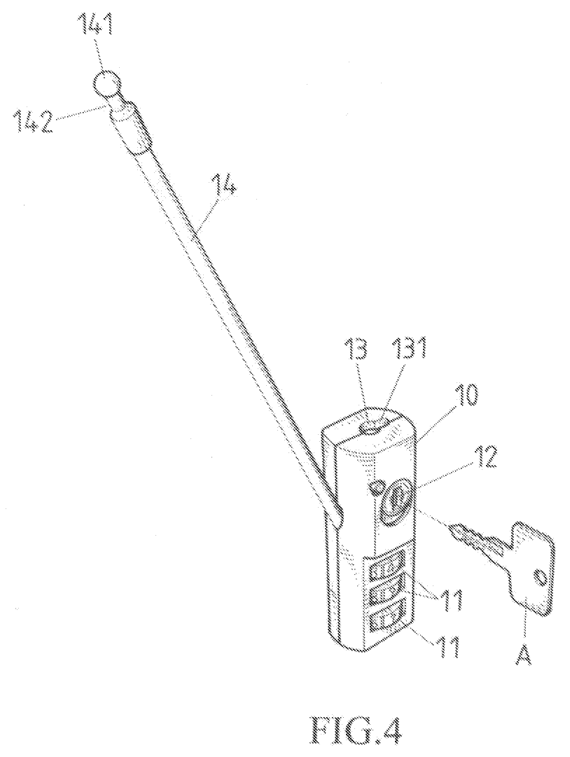

Referring to FIG. 4, a housing 10 of the present invention comprises three dials 11 and a key hole 12, wherein a padlock enables using the dials 11 or inserting a key A into the key hole 12, to open the lock. Wherein a key A is inserted into the key hole 12 in a direction perpendicular to a shaft in the dials 11 (not shown in the drawings). A top end of the housing 10 is provided with a hole 13 and a tail end of a cable 14 is obliquely fixed in a side of the housing 10. An inner side of a head end 141 at the other end of the cable 14 is a neck part 142, the head end 141 of the cable 14 can be put into the hole 13 of the housing 10 and the neck part 142 can displace in a slot 131 which is connected to the hole 13.

According to the present invention, the padlock brings following excellences:
1. As the tail end of the cable 14 is obliquely fixed at the side of the housing 10, a space of the housing 10 can be diminished smaller and tinier, so as to form a narrower lockset.
2. When the housing 10 is hit, as the cable 14 is obliquely combined with the housing 10, the cable 14 is not likely to be damaged.
3. As the housing 10 is not provided with two lock holes on a same surface or a single round hole and the structure for fixing the tail end of the cable 14, a phenomenon that one side of the housing 10 is weaker and thinner will not occur.
4. As the head and tail ends of the cable 14 are not fixed on a same surface of the housing 10, a phenomenon that the neck part 141 of the cable 14 is not easy to be put into the housing 10 will not occur.

Conclusive from the above according to the present invention, the tail end of the cable is obliquely fixed at the side of the housing and the top surface of the housing is provided with the hole to facilitate inserting with the head end of the cable. Wherein a key is inserted into the key hole in a direction perpendicular to a shaft in the dials. Therefore, the housing can be designed narrower, tinier and more sophisticated.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claim is:

1. A two-way opened padlock comprising three dials and a key hole, wherein the padlock is unlocked either by using the dials or by inserting a key into the key hole, a housing is provided with a hole which is connected with a slot and a cable is provided with a head end and a tail end, an inner side of the head end being a neck part which displaces to the hole in the slot, the head end being separated from the housing from the hole and a tail end of the cable being obliquely fixed on the housing.

2. The two-way opened padlock according to claim 1, wherein the tail end of the cable is fixed on the housing in a direction different from a direction in which the head end of the cable is inserted into the hole.

3. The two-way opened padlock according to claim 1, wherein the key is inserted into the key hole in a direction perpendicular to a shaft in the dials.
